(19) United States
(12) Patent Application Publication
(10) Pub. No.: US 2023/0155765 A1
(43) Pub. Date: May 18, 2023

(54) Sounding Reference Signal Resource Capacity Enhancement for Wireless Communications

(71) Applicant: Apple Inc., Cupertino, CA (US)

(72) Inventors: Yushu Zhang, Beijing (CN); Chunhai Yao, Beijing (CN); Chunxuan Ye, San Diego, CA (US); Dawi Zhang, Saratoga, CA (US); Haijing Hu, Beijing (CN); Haitong Sun, Cupertino, CA (US); Hong He, Cupertino, CA (US); Jie Cui, San Jose, CA (US); Oghenekome Oteri, San Diego, CA (US); Wei Zeng, San Diego, CA (US); Weldong Yang, San Diego, CA (US); Yakun Sun, San Jose, CA (US); Yang Tang, San Jose, CA (US); Yuchul Kim, San Jose, CA (US)

(21) Appl. No.: 17/916,898

(22) PCT Filed: Apr. 8, 2020
(86) PCT No.: PCT/CN2020/083672

§ 371 Date: Oct. 4, 2022

(51) Int. Cl. H04L 5/00

(52) U.S. Cl. CPC H04L 5/0048; H04L 5/0012

(57) ABSTRACT

Features for increasing sounding reference signal (SRS) resource capacity for wireless communications may include introducing a larger comb size with comb hopping, providing support to determine the slot offset and/or comb offset for aperiodic SRS based on downlink control information (DCI) alone or based on both DCI and radio resource control (RRC), applying RB level frequency hopping within an SRS resource across different symbols, and/or applying time domain orthogonal cover code (TD-OCC) to symbols within an SRS resource. The TD-OCC may be applied to SRS for codebook, non-codebook and antenna switching, and may also be applied simultaneously with comb hopping and/or RB level hopping in certain scenarios.

### PRIORITY CLAIM

This application is a national phase entry of PCT application number PCT/CN2020/083672, entitled “Sounding Reference Signal Resource Capacity Enhancement for Wireless Communications,” filed Apr. 8, 2020, which is hereby incorporated by reference in its entirety as though fully and completely set forth herein.

The claims in the instant application may be different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### FIELD OF THE INVENTION

The present application relates to wireless communications, and more particularly to providing Sounding Reference Signal (SRS) capacity enhancement for wireless communications, e.g. for 3GPP New Radio (NR) communications.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (WCDMA, TDS-CDMA), LTE, LTE Advanced (LTE-A), HSPA, 3GPP2 CDMA2000 (e.g., 1xRTT, 1xEV-DO, HRPD, eHRPD), IEEE 802.11 (WLAN or Wi-Fi), IEEE 802.16 (WiMAX), BLUETOOTH™, etc. A proposed next telecommunications standards moving beyond the current International Mobile Telecommunications-Advanced (IMT-Advanced) Standards is called 5th generation mobile networks or 5th generation wireless systems, referred to as 3GPP NR (otherwise known as 5G-NR for 5G New Radio, also simply referred to as NR). NR proposes a higher capacity for a higher density of mobile broadband users, also supporting device-to-device, ultra-reliable, and massive machine communications, as well as lower latency and lower battery consumption, than LTE standards.

The ever increasing number of features and functionality introduced in wireless communication devices also creates a continuous need for improvement in both wireless communications and in wireless communication devices. In particular, it is important to ensure the accuracy of transmitted and received signals through user equipment devices (UE), e.g., through wireless devices such as cellular phones, base stations and relay stations used in wireless cellular communications. In many instances, modern wireless communications networks use MIMO (multiple-in-multiple-out) technology to achieve high data rates. One MIMO technique is beamforming, which permits targeted illumination of specific areas, making it possible to improve transmission to users at the far edges of cellular coverage. Many wireless communications standards such as WLAN and WiMAX™, LTE and NR incorporate beamforming among their many features. Beamforming is particularly important for the time division duplex (TDD) mode in LTE and NR.

Wireless communication standards, e.g. 3GPP LTE and 3GPP NR also make provisions for additional signaling intended to improve communications. One example is the Sounding Reference Signal (SRS), which is a reference signal transmitted by the UE in the uplink direction and is used by the base station to estimate the uplink channel quality over a wider bandwidth. The base station may use this information for uplink frequency selective scheduling, and may also use SRS for uplink timing estimation as part of a timing alignment procedure, particularly when there are no PUSCH/PUCCH transmissions in the uplink for an extended period of time, therefore relying on SRS for uplink timing estimation. SRS does not need to be transmitted in the same physical resource blocks where PUSCH is transmitted as SRS may stretch over a larger frequency range. There are two main SRS transmission modes, wideband and frequency-hopping. In wideband mode, one single transmission of the SRS covers the entire bandwidth of interest. The channel quality estimate is obtained within a single symbol. However, under poor channel conditions this mode may yield poor channel estimates. In frequency-hopping mode, the SRS transmission is split into a series of narrowband transmissions that cover the entire bandwidth of interest. This typically the preferred mode under poor channel conditions.

SRS is considered to be an important uplink signal which can be used for uplink (UL) channel state information (CSI) measurement, downlink (DL) CSI measurement based on UL/DL channel reciprocity, as well as beam measurement and selection. A UE can be configured with multiple SRS resource sets having different uses, e.g. codebook, non-codebook, beam management and antenna switching. Each SRS resource set can include 1 or more than 1 SRS resources, and each SRS resource can be transmitted in 1, 2, or 4 symbols. In the frequency domain, either comb2 or comb4 can be used, which is configured via RRC signaling. Because of the importance of the SRS, a UE typically uses resources dedicated specifically to SRS transmission. However, as the number of UEs in a network or cell increases, the resource capacity for provisioning dedicated SRS resources may become an issue. It may therefore be beneficial to enhance resource capacity for resources dedicated to SRS transmission.

Other corresponding issues related to the prior art will become apparent to one skilled in the art after comparing such prior art with the disclosed embodiments as described herein.

### SUMMARY OF THE INVENTION

Embodiments are presented herein of, inter alia, of methods for implementing enhanced resource capacity for resources dedicated to transmission of sounding reference signals (SRSs) for wireless communications, for example for 3GPP New Radio (NR) communications. Embodiments are further presented herein for wireless communication systems containing user equipment (UE) devices and/or base stations communicating with each other within the wireless communication systems.

In order to increase resource capacity for resources dedicated to the transmission of SRSs, a larger comb size with comb hopping may be introduced. In addition, support may be provided to determine the slot offset and/or comb offset for aperiodic SRS based on downlink control information (DCI) alone or based on both DCI and radio resource control (RRC). Furthermore, RB level frequency hopping within an SRS resource across different symbols may be applied, and/or time domain orthogonal cover code (TD-OCC) may be applied to symbols within an SRS resource. The TD-OCC may be applied to SRS for codebook, non-codebook and antenna switching, and may also be applied simultaneously with comb hopping and/or RB level hopping within individual time granularities.

Pursuant to the above, a device may transmit an SRS using a resource that includes a specified number of symbols, transmitting the SRS over a different respective subcarrier in at least two symbols across the specified number of symbols (comb hopping) or transmitting the SRS over different respective resource blocks (RBs) in at least two symbols across the specified number of symbols (RB level frequency hopping or RB hopping). The device may also apply time domain orthogonal cover code (TD-OCC) to at least two symbols to differentiate the device from other devices that may be using the same resource for transmitting respective SRSs. When transmitting the SRS over the different respective resource blocks, a different precoder may be applied to each different (SRS) symbol. Whether or not a different precoder is applied to each different symbol may be either predetermined or configured by higher layer signaling. In some embodiments, when different precoders are applied to different symbols, physical resource blocks for a physical uplink data channel in a non-codebook based transmission corresponding to an SRS symbol may be considered as a physical resource block group. Offsets of the different respective RBs with respect to each other for RB level frequency hopping may be configured by radio resource control and/or downlink control information. The offsets may be based on the number of allocated RBs per symbol. In addition, a time granularity both comb hopping and RB hopping may be configured by higher layer signaling and/or downlink control information. In some embodiments, the TD-OCC may be applied within each time granularity, and may be configured by higher layer signaling and/or downlink control information. The TD-OCC may be applied for codebook SRS transmission, non-codebook SRS transmission, and/or antenna switching SRS transmission.

Note that the techniques described herein may be implemented in and/or used with a number of different types of devices, including but not limited to, base stations, access points, cellular phones, portable media players, tablet computers, wearable devices, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 shows an exemplary simplified block diagram illustrative of cellular communication circuitry, according to some embodiments;

FIG. 6 shows an exemplary diagram illustrating sounding reference signal (SRS) resource allocation;

FIG. 7 shows an exemplary diagram illustrating SRS resource allocation using comb hopping, according to some embodiments;

FIG. 8 shows an exemplary diagram illustrating SRS resource allocation using resource block (RB) level frequency hopping across different symbols, according to some embodiments;

FIG. 9 shows an exemplary diagram illustrating SRS resource allocation using RB level frequency hopping across different symbols with usage set to non-codebook, according to some embodiments;

FIG. 10 shows an exemplary diagram illustrating SRS resource allocation with time domain orthogonal cover code (TD-OCC) applied to symbols, according to some embodiments;

FIG. 11 shows an exemplary diagram illustrating SRS resource allocation with TD-OCC and comb hopping enabled, according to some embodiments; and

FIG. 12 shows an exemplary diagram illustrating SRS resource allocation with TD-OCC and RB level hopping enabled, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION OF THE EMBODIMENTS

### Acronyms

Various acronyms are used throughout the present application. Definitions of the most prominently used acronyms that may appear throughout the present application are provided below:
APR: Applications Processor
BS: Base Station
BSR: Buffer Size Report
CMR: Change Mode Request
CRC: Cyclic Redundancy Check
CSI: Channel State Information
DCI: Downlink Control Information
DL: Downlink (from BS to UE)
DYN: Dynamic
FDD: Frequency Division Duplexing
FT: Frame Type
GC-PDCCH: Group Common Physical Downlink Control Channel
GPRS: General Packet Radio Service
GSM: Global System for Mobile Communication
GTP: GPRS Tunneling Protocol
IR: Initialization and Refresh state
LAN: Local Area Network
LTE: Long Term Evolution
MAC: Media Access Control
MAC-CE: MAC Control Element
MIB: Master Information Block
MIMO: Multiple-In Multiple-Out
OSI: Open System Interconnection
PBCH: Physical Broadcast Channel
PDCCH: Physical Downlink Control Channel
PDCP: Packet Data Convergence Protocol
PDN: Packet Data Network
PDSCH: Physical Downlink Shared Channel
PDU: Protocol Data Unit
QCL: Quasi Co-Location
RACH: Random Access Procedure
RAT: Radio Access Technology
RB: Resource Block
RF: Radio Frequency
RMSI: Remaining Minimum System Information
ROHC: Robust Header Compression
RRC: Radio Resource Control
RS: Reference Signal (Symbol)
RSI: Root Sequence Indicator
RTP: Real-time Transport Protocol
RX: Reception/Receive
SID: System Identification Number
SGW: Serving Gateway
SRS: Sounding Reference Signal
SS: Search Space
SSB: Synchronization Signal Block
TBS: Transport Block Size
TCI: Transmission Configuration Indication
TDD: Time Division Duplexing
TRS: Tracking Reference Signal
TX: Transmission/Transmit
UE: User Equipment
UL: Uplink (from UE to BS)
UMTS: Universal Mobile Telecommunication System
Wi-Fi: Wireless Local Area Network (WLAN) RAT based on the Institute of Electrical and Electronics Engineers' (IEEE) 802.11 standards
WLAN: Wireless LAN

### Terms

The following is a glossary of terms that may appear in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—Includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems devices which perform wireless communications. Also referred to as wireless communication devices, many of which may be mobile and/or portable. Examples of UE devices include mobile telephones or smart phones (e.g., iPhone™, Android™-based phones) and tablet computers such as iPad™, Samsung Galaxy™, etc., gaming devices (e.g. Sony Play Station™, Microsoft XBox™, etc.), portable gaming devices (e.g., Nintendo DS™, PlayStation Portable™, Gameboy Advance™, iPod™), laptops, wearable devices (e.g. Apple Watch™, Google Glass™), PDAs, portable Internet devices, music players, data storage devices, or other handheld devices, unmanned aerial vehicles (e.g., drones) and unmanned aerial controllers, etc. Various other types of devices would fall into this category if they include Wi-Fi or both cellular and Wi-Fi communication capabilities and/or other wireless communication capabilities, for example over short-range radio access technologies (SRATs) such as BLUETOOTH™, etc. In general, the term “UE” or “UE device” may be broadly defined to encompass any electronic, computing, and/or telecommunications device (or combination of devices) which is capable of wireless communication and may also be portable/mobile.

Wireless Device (or wireless communication device)—any of various types of computer systems devices which performs wireless communications using WLAN communications, SRAT communications, Wi-Fi communications and the like. As used herein, the term “wireless device” may refer to a UE device, as defined above, or to a stationary device, such as a stationary wireless client or a wireless base station. For example a wireless device may be any type of wireless station of an 802.11 system, such as an access point (AP) or a client station (UE), or any type of wireless station of a cellular communication system communicating according to a cellular radio access technology (e.g. LTE, CDMA, GSM), such as a base station or a cellular telephone, for example.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processor—refers to various elements (e.g. circuits) or combinations of elements that are capable of performing a function in a device, e.g. in a user equipment device or in a cellular network device. Processors may include, for example: general purpose processors and associated memory, portions or circuits of individual processor cores, entire processor cores or processing circuit cores, processing circuit arrays or processor arrays, circuits such as ASICs (Application Specific Integrated Circuits), programmable hardware elements such as a field programmable gate array (FPGA), as well as any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band (or Frequency Band)—The term “band” has the full breadth of its ordinary meaning, and at least includes a section of spectrum (e.g., radio frequency spectrum) in which channels are used or set aside for the same purpose. Furthermore, “frequency band” is used to denote any interval in the frequency domain, delimited by a lower frequency and an upper frequency. The term may refer to a radio band or an interval of some other spectrum. A radio communications signal may occupy a range of frequencies over which (or where) the signal is carried. Such a frequency range is also referred to as the bandwidth of the signal. Thus, bandwidth refers to the difference between the upper frequency and lower frequency in a continuous band of frequencies. A frequency band may represent one communication channel or it may be subdivided into multiple communication channels. Allocation of radio frequency ranges to different uses is a major function of radio spectrum allocation.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Station (STA)—The term “station” herein refers to any device that has the capability of communicating wirelessly, e.g. by using the 802.11 protocol. A station may be a laptop, a desktop PC, PDA, access point or Wi-Fi phone or any type of device similar to a UE. An STA may be fixed, mobile, portable or wearable. Generally in wireless networking terminology, a station (STA) broadly encompasses any device with wireless communication capabilities, and the terms station (STA), wireless client (UE) and node (BS) are therefore often used interchangeably.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Transmission Scheduling—Refers to the scheduling of transmissions, such as wireless transmissions. In some implementations of cellular radio communications, signal and data transmissions may be organized according to designated time units of specific duration during which transmissions take place. As used herein, the term “slot” has the full extent of its ordinary meaning, and at least refers to a smallest (or minimum) scheduling time unit in wireless communications. For example, in 3GPP LTE, transmissions are divided into radio frames, each radio frame being of equal (time) duration (e.g. 10 ms). A radio frame in 3GPP LTE may be further divided into a specified number of (e.g. ten) subframes, each subframe being of equal time duration, with the subframes designated as the smallest (minimum) scheduling unit, or the designated time unit for a transmission. Thus, in a 3GPP LTE example, a “subframe” may be considered an example of a “slot” as defined above. Similarly, a smallest (or minimum) scheduling time unit for 5G NR (or NR, for short) transmissions is referred to as a “slot”. In different communication protocols the smallest (or minimum) scheduling time unit may also be named differently.

Resources—The term “resource” has the full extent of its ordinary meaning and may refer to frequency resources and time resources used during wireless communications. As used herein, a resource element (RE) refers to a specific amount or quantity of a resource. For example, in the context of a time resource, a resource element may be a time period of specific length. In the context of a frequency resource, a resource element may be a specific frequency bandwidth, or a specific amount of frequency bandwidth, which may be centered on a specific frequency. As one specific example, a resource element may refer to a resource unit of 1 symbol (in reference to a time resource, e.g. a time period of specific length) per 1 subcarrier (in reference to a frequency resource, e.g. a specific frequency bandwidth, which may be centered on a specific frequency). A resource element group (REG) has the full extent of its ordinary meaning and at least refers to a specified number of consecutive resource elements. In some implementations, a resource element group may not include resource elements reserved for reference signals. A control channel element (CCE) refers to a group of a specified number of consecutive REGs. A resource block (RB) refers to a specified number of resource elements made up of a specified number of subcarriers per specified number of symbols. Each RB may include a specified number of subcarriers. A resource block group (RBG) refers to a unit including multiple RBs. The number of RBs within one RBG may differ depending on the system bandwidth.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

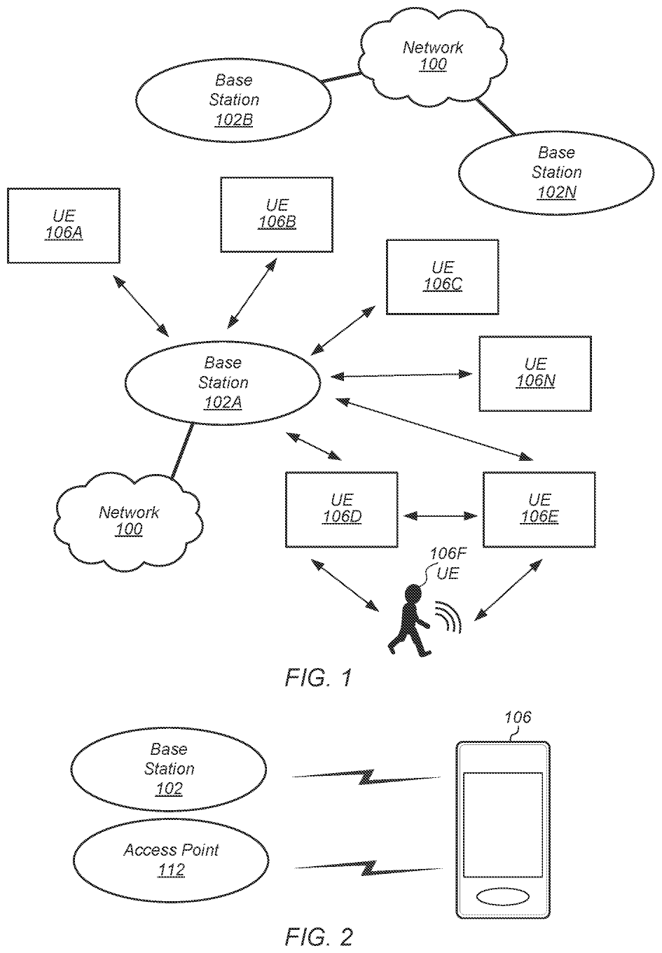

### FIGS. 1 and 2—Exemplary Communication Systems

FIG. 1 illustrates an exemplary (and simplified) wireless communication system, according to some embodiments. It is noted that the system of FIG. 1 is merely one example of a possible system, and embodiments may be implemented in any of various systems, as desired.

As shown, the exemplary wireless communication system includes base stations 102A through 102N, also collectively referred to as base station(s) 102 or base station 102. As shown in FIG. 1, base station 102A communicates over a transmission medium with one or more user devices 106A through 106N. Each of the user devices may be referred to herein as a “user equipment” (UE) or UE device. Thus, the user devices 106A through 106N are referred to as UEs or UE devices, and are also collectively referred to as UE(s) 106 or UE 106. Various ones of the UE devices may operate with enhanced resource capacity for resources dedicated to transmission of SRSs, according to various embodiments disclosed herein.

The base station 102A may be a base transceiver station (BTS) or cell site, and may include hardware that enables wireless communication with the UEs 106A through 106N. The base station 102A may also be equipped to communicate with a network 100, e.g., a core network of a cellular service provider, a telecommunication network such as a public switched telephone network (PSTN), and/or the Internet, neutral host or various CBRS (Citizens Broadband Radio Service) deployments, among various possibilities. Thus, the base station 102A may facilitate communication between the user devices and/or between the user devices and the network 100. In particular, the cellular base station 102A may provide UEs 106 with various telecommunication capabilities, such as voice, SMS and/or data services. The communication area (or coverage area) of the base station may be referred to as a “cell.” It should also be noted that “cell” may also refer to a logical identity for a given coverage area at a given frequency. In general, any independent cellular wireless coverage area may be referred to as a “cell”. In such cases a base station may be situated at particular confluences of three cells. The base station, in this uniform topology, may serve three 120 degree beam width areas referenced as cells. Also, in case of carrier aggregation, small cells, relays, etc. may each represent a cell. Thus, in carrier aggregation in particular, there may be primary cells and secondary cells which may service at least partially overlapping coverage areas but on different respective frequencies. For example, a base station may serve any number of cells, and cells served by a base station may or may not be collocated (e.g. remote radio heads). As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network, and may further also be considered at least a part of the UE communicating on the network or over the network.

The base station(s) 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G-NR (NR, for short), 3GPP2 CDMA2000 (e.g., 1xRTT, 1xEV-DO, HRPD, eHRPD), Wi-Fi, WiMAX etc. Note that if a base station(s) 102 are implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’. In some embodiments, the base station(s) 102 may operate with enhanced resource capacity for resources dedicated to transmission of SRSs, as described herein. Depending on a given application or specific considerations, for convenience some of the various different RATs may be functionally grouped according to an overall defining characteristic. For example, all cellular RATs may be collectively considered as representative of a first (form/type of) RAT, while Wi-Fi communications may be considered as representative of a second RAT. In other cases, individual cellular RATs may be considered individually as different RATs. For example, when differentiating between cellular communications and Wi-Fi communications, “first RAT” may collectively refer to all cellular RATs under consideration, while “second RAT” may refer to Wi-Fi. Similarly, when applicable, different forms of Wi-Fi communications (e.g. over 2.4 GHz vs. over 5 GHz) may be considered as corresponding to different RATs. Furthermore, cellular communications performed according to a given RAT (e.g. LTE or NR) may be differentiated from each other on the basis of the frequency spectrum in which those communications are conducted. For example, LTE or NR communications may be performed over a primary licensed spectrum as well as over a secondary spectrum such as an unlicensed spectrum and/or spectrum that was assigned to Citizens Broadband Radio Service (CBRS). Overall, the use of various terms and expressions will always be clearly indicated with respect to and within the context of the various applications/embodiments under consideration.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services. Base station 102A and other similar base stations (such as base stations 102B . . . 102N) operating according to the same or a different cellular communication standard may thus be provided as a network of cells, which may provide continuous or nearly continuous overlapping service to UEs 106A-106N and similar devices over a geographic area via one or more cellular communication standards.

Thus, while base station 102A may act as a “serving cell” for UEs 106A-106N as illustrated in FIG. 1, each one of UE(s) 106 may also be capable of receiving signals from (and possibly within communication range of) one or more other cells (which might be provided by base stations 102B-102N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-102B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transmission and reception points (TRPs). In addition, a UE capable of operating according to 5G NR may be connected to one or more TRPs within one or more gNBs.

As mentioned above, UE(s) 106 may be capable of communicating using multiple wireless communication standards. For example, a UE might be configured to communicate using any or all of a 3GPP cellular communication standard (such as LTE or NR) or a 3GPP2 cellular communication standard (such as a cellular communication standard in the CDMA2000 family of cellular communication standards). Base station 102 and other similar base stations operating according to the same or a different cellular communication standard may thus be provided as one or more networks of cells, which may provide continuous or nearly continuous overlapping service to UE 106 and similar devices over a wide geographic area via one or more cellular communication standards.

The UE(s) 106 might also or alternatively be configured to communicate using WLAN, BLUETOOTH™, BLUETOOTH™ Low-Energy, one or more global navigational satellite systems (GNSS, e.g., GPS or GLONASS), one and/or more mobile television broadcasting standards (e.g., ATSC-M/H or DVB-H), etc. Other combinations of wireless communication standards (including more than two wireless communication standards) are also possible. Furthermore, UE(s) 106 may also communicate with Network 100, through one or more base stations or through other devices, stations, or any appliances not explicitly shown but considered to be part of Network 100. UE(s) 106 communicating with a network may therefore be interpreted as the UEs 106 communicating with one or more network nodes considered to be a part of the network and which may interact with the UE(s) 106 to conduct communications with the UE(s) 106 and in some cases affect at least some of the communication parameters and/or use of communication resources of the UE(s) 106.

Furthermore, as also illustrated in FIG. 1, at least some of the UE(s) 106, e.g. 106D and 106E may represent vehicles communicating with each other and with base station 102A, via cellular communications such as 3GPP LTE and/or 5G-NR for example. In addition, UE 106F may represent a pedestrian who is communicating and/or interacting with the vehicles represented by UEs 106D and 106E in a similar manner. Further aspects of vehicles communicating in a network exemplified in FIG. 1 are disclosed in the context of vehicle-to-everything (V2X) communications such as the communications specified by 3GPP TS 22.185 V 14.3.0, among others.

FIG. 2 illustrates an exemplary user equipment 106 (e.g., one of the devices 106A through 106N) in communication with the base station 102 and an access point 112, according to some embodiments. The UE 106 may be a device with both cellular communication capability and non-cellular communication capability (e.g., BLUETOOTH™, Wi-Fi, and so forth) such as a mobile phone, a hand-held device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, NR, WLAN, or GNSS. Other combinations of wireless communication standards are also possible.

The UE 106 may include one or more antennas for communicating using one or more wireless communication protocols according to one or more RAT standards, .g. those previously mentioned above. In some embodiments, the UE 106 may share one or more parts of a receive chain and/or transmit chain between multiple wireless communication standards. The shared radio may include a single antenna, or may include multiple antennas (e.g., for MIMO) for performing wireless communications. Alternatively, the UE 106 may include separate transmit and/or receive chains (e.g., including separate antennas and other radio components) for each wireless communication protocol with which it is configured to communicate. As another alternative, the UE 106 may include one or more radios or radio circuitry which are shared between multiple wireless communication protocols, and one or more radios which are used exclusively by a single wireless communication protocol. For example, the UE 106 may include a shared radio for communicating using either of LTE or CDMA2000 1xRTT or NR, and separate radios for communicating using each of Wi-Fi and BLUETOOTH™. Other configurations are also possible.

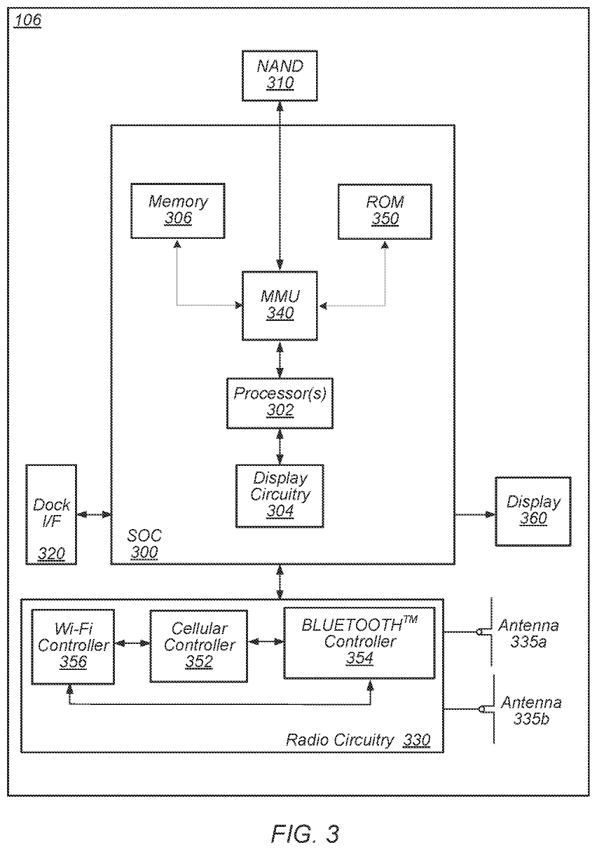

### FIG. 3—Block Diagram of an Exemplary UE

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio circuitry 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to the computer system), the display 360, and wireless communication circuitry (e.g., for LTE, LTE-A, NR, CDMA2000, BLUETOOTH™, Wi-Fi, GPS, etc.). The UE device 106 may include at least one antenna (e.g. 335a), and possibly multiple antennas (e.g. illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna(s) 335. For example, the UE device 106 may use antenna(s) 335 to perform the wireless communication with the aid of radio circuitry 330. As noted above, the UE may be configured to communicate wirelessly using multiple wireless communication standards in some embodiments.

As further described herein, the UE 106 (and/or base station(s) 102) may include hardware and software components for implementing methods for at least UE 106 to operate with enhanced resource capacity for resources dedicated to transmission of SRSs, as further detailed herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to operate with enhanced resource capacity for resources dedicated to transmission of SRSs according to various embodiments disclosed herein. Processor(s) 302 may also implement various other applications and/or end-user applications running on UE 106.

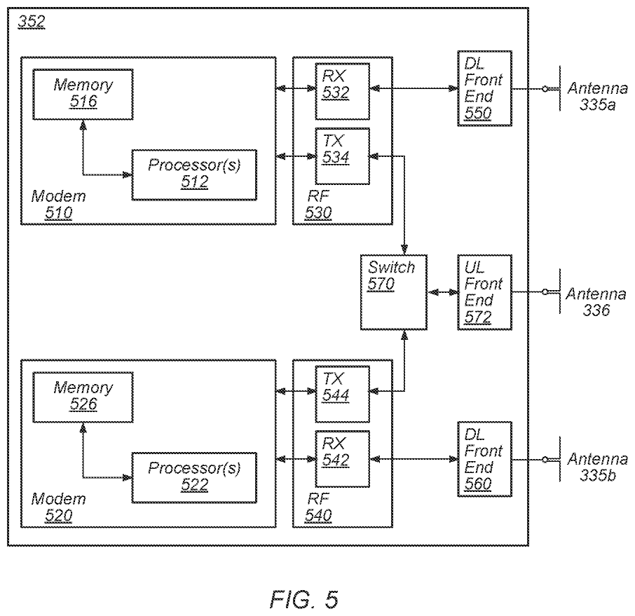

In some embodiments, radio circuitry 330 may include separate controllers dedicated to controlling communications for various respective RAT standards. For example, as shown in FIG. 3, radio circuitry 330 may include a Wi-Fi controller 356, a cellular controller (e.g. LTE and/or NR controller) 352, and BLUETOOTH™ controller 354, and in at least some embodiments, one or more or all of these controllers may be implemented as respective integrated circuits (ICs or chips, for short) in communication with each other and with SOC 300 (and more specifically with processor(s) 302). For example, Wi-Fi controller 356 may communicate with cellular controller 352 over a cell-ISM link or WCI interface, and/or BLUETOOTH™ controller 354 may communicate with cellular controller 352 over a cell-ISM link, etc. While three separate controllers are illustrated within radio circuitry 330, other embodiments have fewer or more similar controllers for various different RATs that may be implemented in UE device 106. For example, at least one exemplary block diagram illustrative of some embodiments of cellular controller 352 is shown in FIG. 5 and will be further described below.

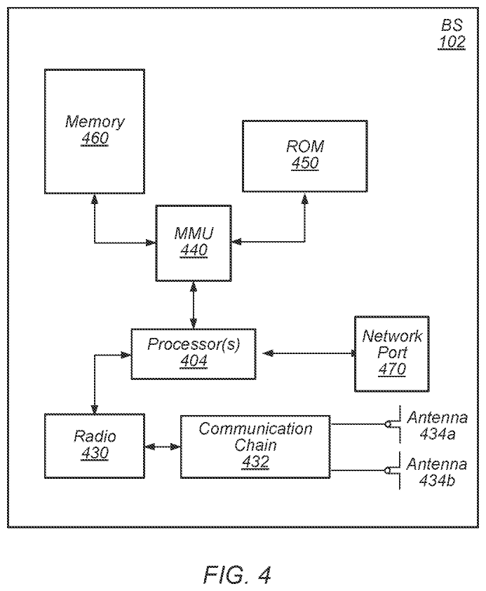

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas, (e.g. illustrated by antennas 434a and 434b) for performing wireless communication with mobile devices and/or other devices. Antennas 434a and 434b are shown by way of example, and base station 102 may include fewer or more antennas. Overall, the one or more antennas, which may include antenna 434a and/or antenna 434b, are collectively referred to as antenna(s) 434. Antenna(s) 434 may be configured to operate as a wireless transceiver and may be further configured to communicate with UE devices 106 via radio circuitry 430. The antenna(s) 434 may communicate with the radio circuitry 430 via communication chain 432. Communication chain 432 may be a receive chain, a transmit chain or both. The radio circuitry 430 may be designed to communicate via various wireless telecommunication standards, including, but not limited to, LTE, LTE-A, 5G-NR (or NR for short), WCDMA, CDMA2000, etc. The processor(s) 404 of the base station 102 may be configured to implement part or all of the methods described herein, e.g., by executing program instructions stored on a memory medium (e.g., a non-transitory computer-readable memory medium), for base station 102 to communicate with a UE device using enhanced resource capacity for resources dedicated to transmission of SRSs as disclosed herein. Alternatively, the processor(s) 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network (s), e.g. it may include at least one Ethernet port, and radio 430 may be designed to communicate according to the Wi-Fi standard. Base station 102 may operate according to the various methods and embodiments as disclosed herein to communicate with UEs with enhanced resource capacity for resources dedicated to transmission of SRSs.

### FIG. 5—Block Diagram of Exemplary Cellular Communication Circuitry

FIG. 5 illustrates an exemplary simplified block diagram illustrative of cellular controller 352, according to some embodiments. It is noted that the block diagram of the cellular communication circuitry of FIG. 5 is only one example of a possible cellular communication circuit; other circuits, such as circuits including or coupled to sufficient antennas for different RATs to perform uplink activities using separate antennas, or circuits including or coupled to fewer antennas, e.g., that may be shared among multiple RATs, are also possible. According to some embodiments, cellular communication circuitry 352 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 352 may couple (e.g., communicatively; directly or indirectly) to one or more antennas, such as antennas 335a-b and 336 as shown. In some embodiments, cellular communication circuitry 352 may include dedicated receive chains (including and/or coupled to (e.g., communicatively; directly or indirectly) dedicated processors and/or radios) for multiple RATs (e.g., a first receive chain for LTE and a second receive chain for 5G NR). For example, as shown in FIG. 5, cellular communication circuitry 352 may include a first modem 510 and a second modem 520. The first modem 510 may be configured for communications according to a first RAT, e.g., such as LTE or LTE-A, and the second modem 520 may be configured for communications according to a second RAT, e.g., such as 5G NR.

As shown, the first modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, the second modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 352 receives instructions to transmit according to the first RAT (e.g., as supported via the first modem 510), switch 570 may be switched to a first state that allows the first modem 510 to transmit signals according to the first RAT (e.g., via a transmit chain that includes transmit circuitry 534 and UL front end 572). Similarly, when cellular communication circuitry 352 receives instructions to transmit according to the second RAT (e.g., as supported via the second modem 520), switch 570 may be switched to a second state that allows the second modem 520 to transmit signals according to the second RAT (e.g., via a transmit chain that includes transmit circuitry 544 and UL front end 572).

As described herein, the first modem 510 and/or the second modem 520 may include hardware and software components for implementing any of the various features and techniques described herein. The processors 512, 522 may be configured to implement part or all of the features described herein, e.g., by executing program instructions stored on a memory medium (e.g., a non-transitory computer-readable memory medium). Alternatively (or in addition), processors 512, 522 may be configured as a programmable hardware element, such as an FPGA (Field Programmable Gate Array), or as an ASIC (Application Specific Integrated Circuit). Alternatively (or in addition) the processors 512, 522, in conjunction with one or more of the other components 530, 532, 534, 540, 542, 544, 550, 570, 572, 335 and 336 may be configured to implement part or all of the features described herein.

In addition, as described herein, processors 512, 522 may include one or more processing elements. Thus, processors 512, 522 may include one or more integrated circuits (ICs) that are configured to perform the functions of processors 512, 522. In addition, each integrated circuit may include circuitry (e.g., first circuitry, second circuitry, etc.) configured to perform the functions of processors 512, 522.

In some embodiments, the cellular communication circuitry 352 may include only one transmit/receive chain. For example, the cellular communication circuitry 352 may not include the modem 520, the RF front end 540, the DL front end 560, and/or the antenna 335b. As another example, the cellular communication circuitry 352 may not include the modem 510, the RF front end 530, the DL front end 550, and/or the antenna 335a. In some embodiments, the cellular communication circuitry 352 may also not include the switch 570, and the RF front end 530 or the RF front end 540 may be in communication, e.g., directly, with the UL front end 572.

### Sounding Reference Signal (SRS) Resources

As previously mentioned, SRS is considered to be an important uplink signal which can be used for uplink (UL) channel state information (CSI) measurement, downlink (DL) CSI measurement based on UL/DL channel reciprocity, as well as beam measurement and selection. A UE may be configured with multiple SRS resources or resource sets, each resource set having a different use, e.g. codebook, non-codebook, beam management and antenna switching. For example, different resource sets may be used for different types of transmissions to facilitate different corresponding measurements. Each SRS resource set may include one SRS resource or more than one SRS resource, and each SRS resource may be transmitted in one or more symbols, e.g. in one, two, or four symbols. For each SRS in the frequency domain, either comb2 or comb4 may be used, as configured via RRC signaling. In case of comb2 the SRS may occupy every other subcarrier of consecutive subcarriers within a symbol, while in case of comb4 the SRS may occupy every fourth subcarrier of consecutive subcarriers within a symbol.

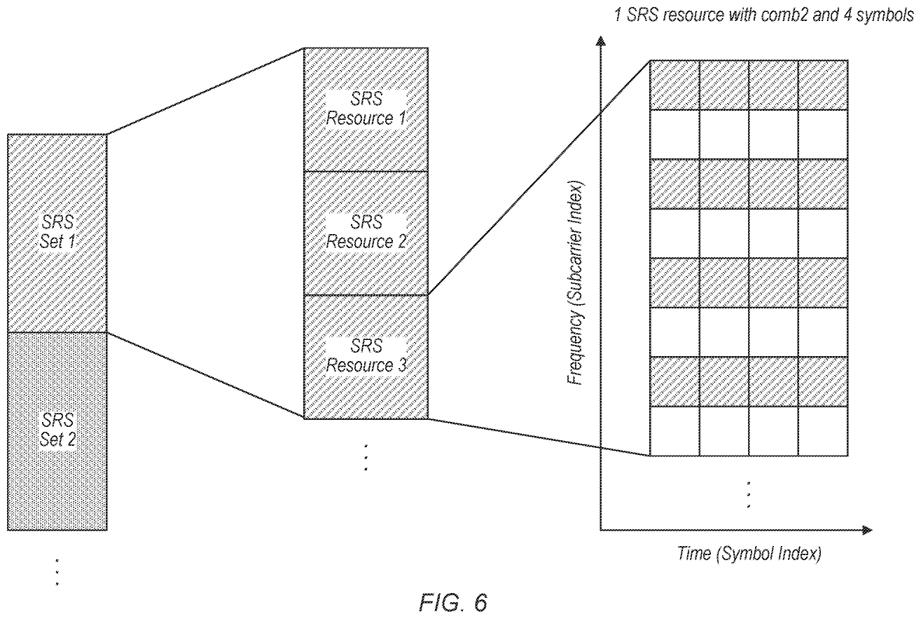

FIG. 6 shows an exemplary diagram illustrating sounding reference signal (SRS) resource allocation. There may be multiple SRS resource sets (SRS set 1 and SRS set 2), with each resource set including multiple SRS resources (e.g. SRS set 1 may include SRS resource 1, SRS resource 2, SRS resource 3, etc.) Details are shown for SRS resource 3, with comb2 and 4 symbols. Thus, according to the diagram shown in FIG. 6, SRS on SRS resource 3 is transmitted in four symbols on every other subcarrier of each symbol of the fours symbols.

Because of the importance of the SRS, a UE typically uses resources dedicated specifically to the transmission of SRS. As the number of UEs in a network or cell increases, the resource capacity for provisioning dedicated SRS resources may pose a problem. Furthermore, for power limited UEs, an increased number of SRS instances with frequency hopping may be required in order to measure wideband CSI, since one SRS resource can only be transmitted within a limited number of resource blocks (RBs). From one perspective, then, SRS has multiple functionalities, and SRS resources are dedicated for each UE. In contrast to downlink broadcast signals, for example, SRS is received by base stations on resources dedicated specifically for SRS transmission, with a different respective resource or a different respective set of resources assigned to/for each UE specifically for SRS transmission. Some UEs may be located at a cell's edge, and for such UEs SRS transmission with a wider bandwidth is not possible because the UE is power limited. In such cases the base station needs to schedule a smaller bandwidth for the UE. However, to measure wideband CSI, a wideband SRS is still required. Wireless communications can therefore be improved by increasing resource capacity for resources dedicated to SRS transmissions.

### Larger Comb Size and Comb Hopping

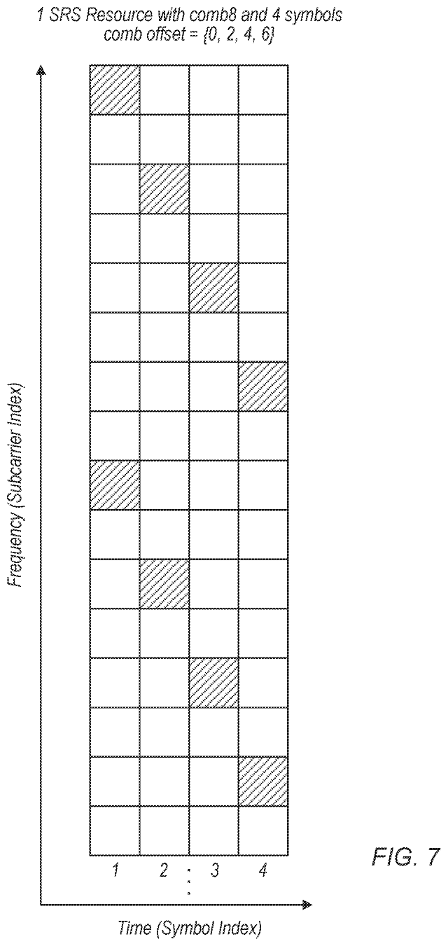

In some embodiments, a possible way of increasing SRS resource capacity may include introducing a larger comb size with comb hopping. For example, a comb size of 8 (comb8) may be introduced in which case the SRS may occupy every eighth subcarrier of each symbol. In this manner the base station may schedule more SRS resources for different UEs. Each resource element (RE) not used for one UE may be used for another UE. By applying comb hopping, different UEs may be scheduled with different comb offsets. Comb hopping may provide better coverage and may be implemented through the use of different comb offsets for different symbols with respect to the subcarriers, e.g. as illustrated in FIG. 7, thereby facilitating the use of more symbols for SRS transmission. FIG. 7 shows an exemplary diagram illustrating SRS resource allocation using comb hopping, according to some embodiments. The comb offset for each symbol may be different, and may be configured by RRC signaling and/or indicated by downlink control information (DCI). In some embodiments, the comb offset for each symbol may be determined based on a comb hopping pattern as well as the comb offset for the first symbol. In some embodiments, a table may be defined for different comb hopping patterns and the comb hopping pattern index may be configured by RRC or DCI. In some embodiments, the comb size may be more than 4, e.g. 8. The decision whether comb hopping is to be applied may be configured via RRC signaling or it may be determined based on the comb size. In the resource allocation example shown in FIG. 7, an SRS resource may include 4 symbols with a comb8 and varying comb offsets for each symbol. As shown in FIG. 7, for symbol 1 the comb offset is 0, for symbol 2 the comb offset is 2, for symbol 1 the comb offset is 4, and for symbol 1 the comb offset is 6. In the example in FIG. 7, the time granularity of the comb hopping (or comb hopping granularity) is 1.

### Slot Offset and/or Comb Offset for Aperiodic SRS Based on DCI or DCI and RRC

In some embodiments, a possible way of increasing SRS resource capacity may include providing support to determine the slot offset and/or comb offset for aperiodic SRS based on DCI alone or based on both DCI and RRC. Presently, the comb offset and slot offset, or SRS triggering offset, for aperiodic SRS is configured by RRC, which presents a challenge for base stations (e.g. gNBs) attempting to multiplex aperiodic SRSs transmitted by multiple UEs. Because a base station cannot easily change the schedule offset for aperiodic SRSs it lacks the flexibility to schedule different SRSs for different UEs in different slots. The base station is therefore unable to multiplex aperiodic SRSs from multiple UEs. An adjustable or changeable slot offset may help alleviate this issue. Accordingly, in some embodiments, an adjustable/changeable slot offset may be implemented. For example, a respective field in DCI may be used to explicitly indicate a slot offset. In some embodiments, a respective field in DCI may similarly be used to explicitly indicate a comb offset. In some embodiments, the starting Control Channel Element (CCE) index for the DCI and RRC signaling may be used to indicate the slot offset and/or comb offset. Use of the CCE index to determine the slot offset allows for dynamic adjustment, as the base station may allocate a different CCE index for the PDCCH. An exemplary formula for determining the slot offset may be defined as:

N_{offset}=max(32,min(1,C_{offset}−N_{CCE}))

where N_{offset} denotes the slot offset for aperiodic SRS, C_{offset} denotes the offset configured by RRC, and N_{CCE} refers to the starting CCE index.
An exemplary formula for determining the comb offset may be defined as:

comb_{offset}=(C_{offset}^{comb}+N_{CCE})modN_{comb}

Where comb_{offset} denotes the comb offset for aperiodic SRS, C_{offset}^{comb} is the comb offset configured by RRC, and N_{comb} is the comb size configured by RRC.

### RB Level Frequency Hopping Applied Within an SRS Resource across Different Symbols

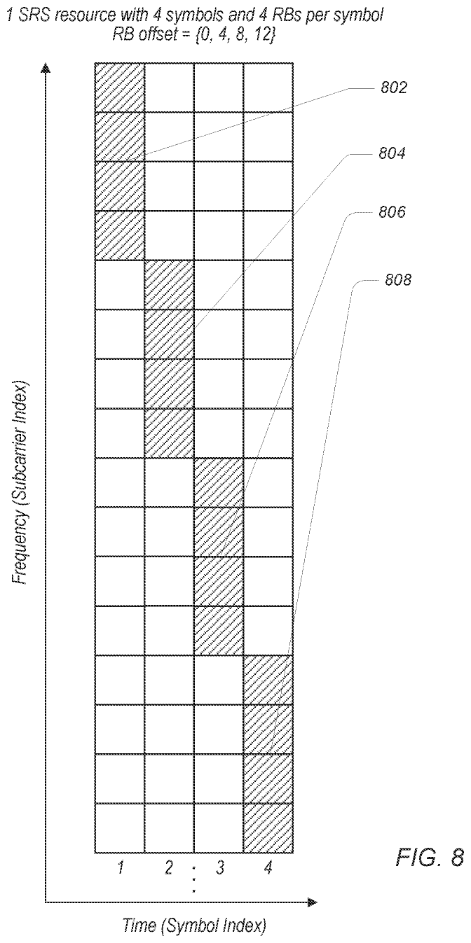

In some embodiments, a possible way of increasing SRS resource capacity may include applying RB level frequency hopping within an SRS resource across different symbols. FIG. 8 shows an exemplary diagram illustrating SRS resource allocation using RB level frequency hopping across different symbols, according to some embodiments. In the example shown in FIG. 8, for a 4-symbol SRS (an SRS using four symbols), the UE transmits the SRS using four different RBs per symbol. The RBs used to transmit SRS and corresponding to a given symbol are shaded. Accordingly, for symbol 1, SRS is transmitted using 4 RBs (frequency resources) 802, for symbol 2, SRS is transmitted using 4 RBs 804, for symbol 3, SRS is transmitted using 4 RBs 806, and for symbol 4, SRS is transmitted using 4 RBs 808. In the example in FIG. 8, the time granularity of the RB hopping (or RB hopping granularity) is 1. This feature may be applied for all types of SRS resources or SRS resources other than SRS for beam management (BM). The RB offset for each SRS symbol may be configured by RRC and/or DCI. The RB offset for each symbol may be determined by the number of allocated RBs. In some embodiments, the RB-hopping patterns may be predefined and the RB-hopping pattern index may be indicated by RRC signaling or DCI.

For SRS for non-codebook based transmission, the determination or decision whether the UE may apply different precoders to different symbols of an SRS resource with RB level frequency hopping may be configured by higher layer signaling (e.g. RRC signaling) or it may be predefined. If the UE has the opportunity to apply different precoders to different SRS symbols, the physical resource blocks (PRBs) for the PUSCH in a non-codebook based transmission corresponding to a SRS symbol may be considered as a Physical Resource block Group (PRG). The base station (e.g. gNB) may assume the precoder within a PRG is consistent. Alternately, e.g. when the UE does not have the opportunity to apply different precoders to different SRS symbols, the base station (e.g. gNB) may use one (1) as the number of PRGs for a PUSCH transmission occasion. To put it another way, for the same PRB index, the same precoder may be used for SRS and the PUSCH. If the UE does not apply a different precoder for different SRS symbols, the precoder for the PUSCH may considered to be a wideband precoder, and thus only a single precoder is applied to the whole band.

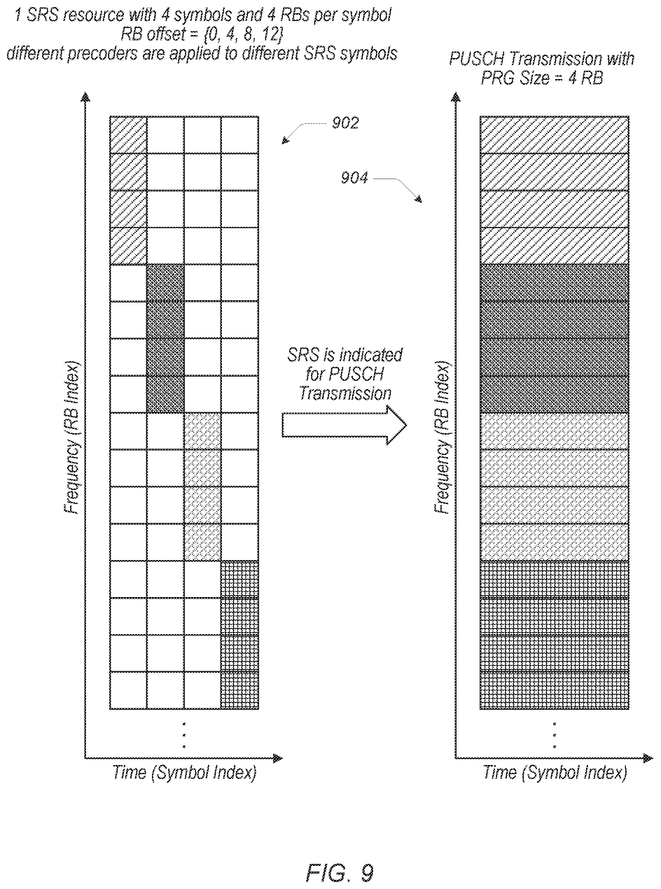

FIG. 9 shows an exemplary diagram illustrating SRS resource allocation using RB level frequency hopping across different symbols with usage set to non-codebook, according to some embodiments. Each different type of shading represents a respective corresponding precoder, as different precoders are applied to different SRS symbols. As indicated in diagram 902 of FIG. 9, an SRS resource may use four (4) symbols and 4 RBs per symbol, with an RB offset of four similar to the example shown in FIG. 8, but in this case each different symbol has a different corresponding precoders applied for the corresponding RBs occupying the symbol. The corresponding diagram 904 illustrates the corresponding PUSCH transmission with a PRG size of 4, with the same precoders applied for the matching frequency resources between SRS transmission and subsequent uplink data transmission.

### Time Domain Orthogonal Cover Code (TD-OCC) Applied to Symbols within an SRS Resource

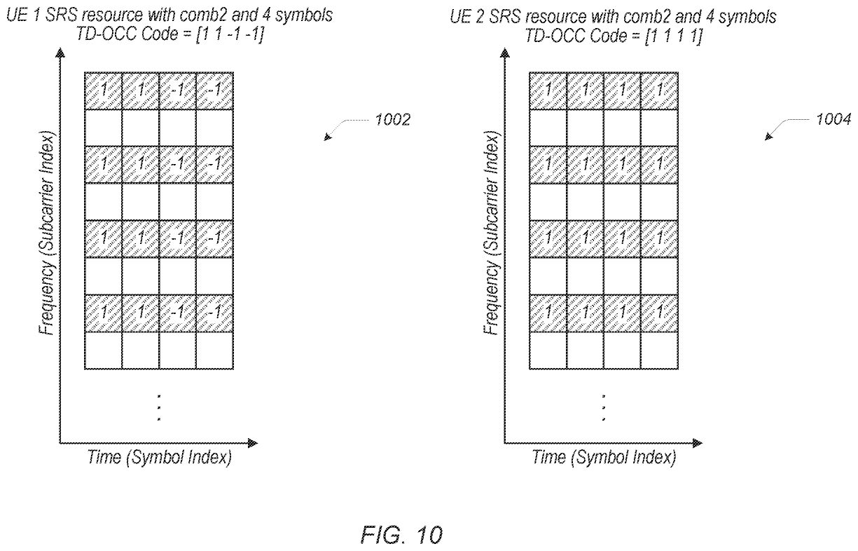

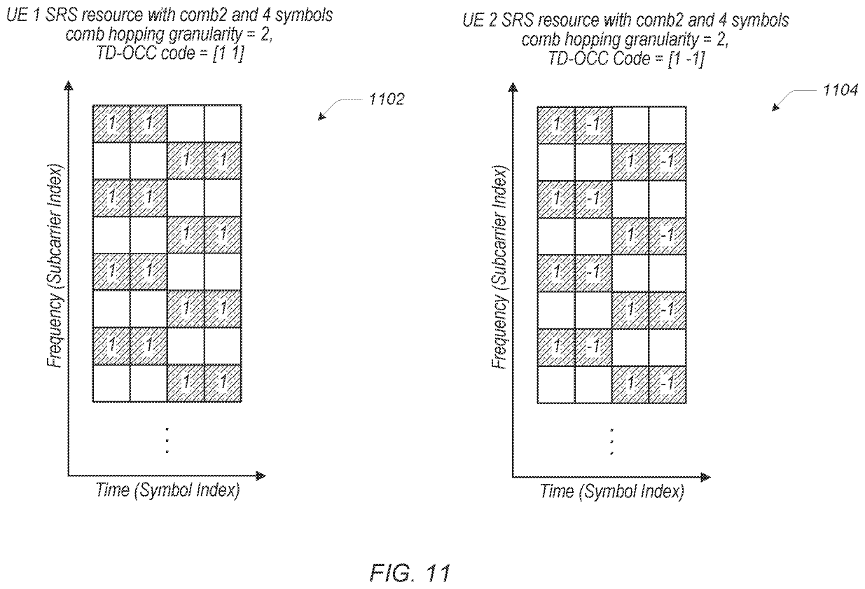

In some embodiments, a possible way of increasing SRS resource capacity may include applying TD-OCC to symbols within an SRS resource. In this case the base station may distinguish between the different UEs based on the different applied TD-OCC. FIG. 10 shows an exemplary diagram illustrating SRS resource allocation with time domain orthogonal cover code (TD-OCC) applied to symbols, according to some embodiments. The code may be configured by RRC and/or DCI, and may be applied to SRS for codebook, non-codebook and antenna switching. In some embodiments, TD-OCC may not be applied to SRS for beam management (BM), and TD-OCC may not be applied when RB/RE level hopping is configured. The base station may apply different beams to receive different symbols. However, in such cases the base station may be unable to distinguish between the UEs based on different TD-OCCs. TD-OCC may be applied based on the assumption that the equivalent channels corresponding to the two symbols are highly correlated. Diagrams 1002 and 1004 in FIG. 10 represent different respective TD-OCCs applied to symbols within an otherwise same SRS resource used by two different UEs. As indicated, as a starting position, both UE1 and UE2 may use the same SRS resource with 4 symbols and comb2 applied. However, as indicated in diagram 1002, a TD-OCC of [1, 1, −1, −1] is applied to the symbols for U1, and as indicated in diagram 1004, a TD-OCC of [1, 1, 1, 1] is applied to the symbols for U2, for each subcarrier index commonly used by UE1 and UE2. The base station may thereby recognize the UE based on the TD-OCC.

FIG. 11 shows an exemplary diagram illustrating SRS resource allocation with TD-OCC and comb hopping enabled, according to some embodiments. The time domain granularity of comb hopping may be configured by RRC signaling and/or DCI. For SRS symbols within each granularity, TD-OCC code may be applied, and the TD-OCC code may be configured by RRC signaling and/or DCI. In this case, TD-OCC may again be applied for the SRS(s) with the same subcarrier index. As indicated, as a starting position, both UE1 and UE2 may use the same SRS resource with 4 symbols and comb2 and comb hopping applied, with a comb hopping granularity of 2. However, as indicated in diagram 1102, a TD-OCC of [1, 1] is applied to the symbols for U1, and as indicated in diagram 1104 a TD-OCC of [1, −1] is applied to the symbols for U2, for each subcarrier index commonly used by UE1 and UE2. The base station may thereby again recognize the UE based on the TD-OCC.

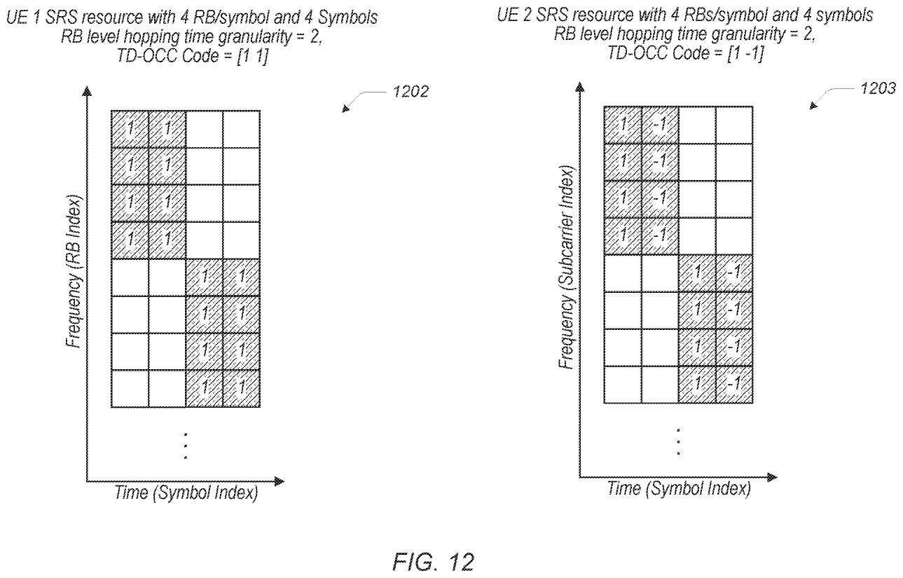

FIG. 12 shows an exemplary diagram illustrating SRS resource allocation with TD-OCC and RB level hopping enabled, according to some embodiments. In this case the TD-OCC may be applied to the SRS symbols within the same RB. When different RB offset and/or RE offset is applied for different symbols, TD-OCC may not be applied in addition. However, for SRS symbols for which the same RB offset and/or RE offset is applied, TD-OCC may also be applied. The time domain granularity of RB level hopping may be configured by RRC signaling and/or DCI. For SRS symbols within each granularity, TD-OCC code may be applied, and the TD-OCC code may be configured by RRC signaling and/or DCI. As shown in FIG. 12, as a starting position, both UE1 and UE2 may use the same SRS resource with 4 symbols and 4 RBs per symbol, with RB level hopping with time granularity of 2. However, as indicated in diagram 2102, a TD-OCC of [1, 1] is applied to the symbols for U1, and as indicated in diagram 1204, a TD-OCC of [1, −1] is applied to the symbols for U2, for each subcarrier index commonly used by UE1 and UE2. The base station may thereby again recognize the UE based on the TD-OCC.sss

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station or appropriate network node, by interpreting each message/signal X received by the UE in the downlink as message/signal X transmitted by the base station/network node, and each message/signal Y transmitted in the uplink by the UE as a message/signal Y received by the base station/network node.

Although the embodiments above have been described in considerable detail, numerous variations and modifications will become apparent to those skilled in the art once the above disclosure is fully appreciated. It is intended that the following claims be interpreted to embrace all such variations and modifications.

1. An apparatus comprising:
a processor configured to cause a device to perform operations comprising:
transmitting a sounding reference signal (SRS) using a resource that comprises a specified number of symbols, wherein transmitting the SRS comprises at least one of:
(a) transmitting the SRS over different respective subcarriers in at least two symbols across the specified number of symbols;
(b) transmitting the SRS over different respective resource blocks (RBs) in at least two symbols across the specified number of symbols; or
(c) applying time domain orthogonal cover code (TD-OCC) to at least two symbols of the specified number of symbols to differentiate the device from other devices using the resource for transmitting respective SRSs.

2. The apparatus of claim 1, wherein when transmitting the SRS comprises (b), a different precoder is applied to each different symbol of the specified number of symbols.

3. The apparatus of claim 2, wherein whether or not a different precoder is applied to each different symbol is either predetermined or is configured by higher layer signaling.

4. The apparatus of claim 2, wherein physical resource blocks for a physical uplink data channel in a non-codebook based transmission corresponding to an SRS symbol are considered as a physical resource block group.

5. The apparatus of claim 1, wherein offsets of the different respective RBs with respect to each other for (b) are configured by one or more of:
radio resource control; or
downlink control information.

6. The apparatus of claim 5, wherein the offsets are based on the number of allocated RBs per symbol.

7. The apparatus of claim 1, wherein a time granularity for (a) and/or (b) is configured by higher layer signaling and/or downlink control information.

8. The apparatus of claim 7, wherein (c) comprises applying the TD-OCC within each time granularity.

9. The apparatus of claim 1, wherein the TD-OCC is configured by higher layer signaling and/or downlink control information.

10. The apparatus of claim 1, wherein the TD-OCC is applied for one or more of:
codebook SRS transmission;
non-codebook SRS transmission; or
antenna switching SRS transmission.

11. A device comprising:
radio circuitry configured to facilitate wireless communications of the device; and
a processor communicatively coupled to the radio circuitry and configured to cause the device to perform operations comprising:
transmitting a sounding reference signal (SRS) using a resource that comprises a specified number of symbols, wherein transmitting the SRS comprises one of:
(a) transmitting the SRS over different respective subcarriers in at least two symbols across the specified number of symbols;
(b) transmitting the SRS over different respective resource blocks (RBs) in at least two symbols across the specified number of symbols; or
(c) applying time domain orthogonal cover code (TD-OCC) to at least two symbols of the specified number of symbols to differentiate the device from other devices using the resource for transmitting respective SRSs.

12. The device of claim 11, wherein when transmitting the SRS comprises (b), a different precoder is applied to each different symbol of the specified number of symbols; and
wherein whether or not a different precoder is applied to each different symbol is either predetermined or is configured by higher layer signaling.

13. The device of claim 11, wherein offsets of the different respective RBs with respect to each other for (b) are based on the number of allocated RBs per symbol and are configured by one or more of:
radio resource control; or
downlink control information.

14. The device of claim 11, wherein a time granularity for (a) and/or (b) is configured by higher layer signaling and/or downlink control information.

15. The device of claim 14, wherein (c) comprises applying the TD-OCC within each time granularity.

16. The device of claim 11, wherein the TD-OCC is configured by higher layer signaling and/or downlink control information.

17. The device of claim 11, wherein the TD-OCC is applied for one or more of:
codebook SRS transmission;
non-codebook SRS transmission; or
antenna switching SRS transmission.

18. A non-transitory memory element storing instructions executable by a processor to cause a device to perform operations comprising:
transmitting a sounding reference signal (SRS) using a resource that comprises a specified number of symbols, wherein transmitting the SRS comprises one of:
(a) transmitting the SRS over different respective subcarriers in at least two symbols across the specified number of symbols;
(b) transmitting the SRS over different respective resource blocks (RBs) in at least two symbols across the specified number of symbols; or
(c) applying time domain orthogonal cover code (TD-OCC) to at least two symbols of the specified number of symbols to differentiate the device from other devices using the resource for transmitting respective SRSs.

19. The non-transitory memory element of claim 18, when transmitting the SRS comprises (b), a different precoder is applied to each different symbol of the specified number of symbols; and
wherein whether or not a different precoder is applied to each different symbol is either predetermined or is configured by higher layer signaling.

20. The non-transitory memory element of claim 18, wherein the TD-OCC is applied for one or more of:
codebook SRS transmission;
non-codebook SRS transmission; or
antenna switching SRS transmission.
